(19) United States
(12) Patent Application Publication
(10) Pub. No.: US 2022/0156543 A1
(43) Pub. Date: May 19, 2022

(54) MANAGEMENT METHOD OF TEST FIXTURES APPLIED TO TEST PROCEDURE

(71) Applicants: Inventec (Pudong) Technology Corporation, Shanghai (CN); INVENTEC CORPORATION, Taipei (TW)

(72) Inventors: CHU-LI HUANG, Taipei (TW); I-Fan Chen, Taipei (TW); Ling-Er Lin, Taipei (TW); Jung-Jen Hsu, Taipei (TW)

(21) Appl. No.: 17/341,860

(22) Filed: Jun. 8, 2021

(30) Foreign Application Priority Data
Nov. 18, 2020 (CN) 202011290197.9

(51) Int. Cl. G06K 19/07; G01D 21/00

(52) U.S. Cl. CPC G06K 19/0723; G01D 21/00

(57) ABSTRACT

A management method of test fixtures applied to a test procedure comprises: binding electronic tags to the test fixtures respectively, obtaining pieces of data respectively stored in the electronic tags by a reader device, obtaining the pieces of data from the reader device and obtaining original usage counts respectively associated with the pieces of data from a storage device by a processing device, determining whether each of the original usage counts does not exceed a threshold by the processing device, performing the test procedure on an object under test using the test fixtures when each of the original usage counts does not exceed the threshold, and after performing the test procedure, generating updated usage counts according to the original usage counts and replacing the original usage counts in the storage device with the updated usage counts respectively by the processing device.

### CROSS-REFERENCE TO RELATED APPLICATIONS

This non-provisional application claims priority under 35 U.S.C. § 119(a) on Patent Application No(s). 202011290197.9 filed in China on Nov. 18, 2020, the entire contents of which are hereby incorporated by reference.

### BACKGROUND

### 1. Technical Field

This disclosure relates to a management method of test fixtures, and particularly to a management method of test fixtures applied to a test procedure.

### 2. Related Art

On the production line in a factory, test devices, test objects or other test fixtures are usually required to test products (objects under test). Since the test fixtures are usually reusable, their management is necessary in the factory.

For example, the test fixtures are memory, and the objects under test are server motherboards. The production line of memory can distribute test elements through a warehouse, and operators prepare the test parts on the server motherboards and send them to the production line for a functional test. The previous part test, such as the identification method of memory, was performed by recording and registering data using 1D barcode, 2D barcode and serial number by the production line and warehouse. At present, there is a back-end management system that uses the method of binding fixtures and machines to count the number of times each test part is used in a test and record the manufacturing process. However, it is difficult to record the number of times the memory is plugged and unplugged, wherein the memory is used to test the functions of the server motherboards during the production of the server motherboards. If the memory is plugged and unplugged too many times, its metal contacts (commonly known as gold fingers) must easily break and cause abnormalities. In addition, the bottleneck of the management of the memory is that the number of pieces of memory used for a server motherboard can be as many as 32 and the pieces of memory are densely arranged, so an optical scanning apparatus cannot quickly scan barcode information at one time. Moreover, after the test, the pieces of memory are separated from the motherboard, and returned to different test machines for the next test after being disassembled by the operators in the factory. If the management of a large number of pieces of memory is not reliable enough and a memory abnormality occurs during the functional test, it causes a lot of waste of production and test time, and even a serious shortage of single-day production.

Furthermore, “group” is used as the smallest unit in the conventional management of memory. A group may include pieces of memory, for example, used in the test of an object under test. However, this management method cannot effectively manage each single piece of memory. If any piece of memory in a group is damaged or fails, the operators often need to check the pieces of memory one by one, which also causes a lot of waste of production and test time.

### SUMMARY

Accordingly, the present disclosure provides a management method of test fixtures applied to a test procedure, comprising: binding electronic tags to the test fixtures respectively; by a reader device, obtaining pieces of data respectively stored in the electronic tags; by a processing device, obtaining the pieces of data from the reader device, and obtaining original usage counts respectively associated with the pieces of data from a storage device; by the processing device, determining whether each of the original usage counts does not exceed a threshold; when each of the original usage counts does not exceed the threshold, performing the test procedure on an object under test using the test fixtures; and after performing the test procedure, by the processing device, generating updated usage counts according to the original usage counts, and replacing the original usage counts in the storage device with the updated usage counts respectively.

In view of the above description, with the management method of text fixtures applied to a test procedure in the present disclosure, individual management of the test fixtures may be achieved, and at the same time, it may be ensured that the usage count of each of the test fixtures does not exceed the threshold.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of devices involved in a management method of test fixtures applied to a test procedure according to an embodiment of the present disclosure;

FIG. 2 is a flow chart of a management method of test fixtures applied to a test procedure according to an embodiment of the present disclosure;

FIG. 3 is a schematic diagram of part of operating environment of a management method of test fixtures applied to a test procedure according to an embodiment of the present disclosure; and

FIG. 4 is a detailed flow chart of a management method of test fixtures applied to a test procedure according to an embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

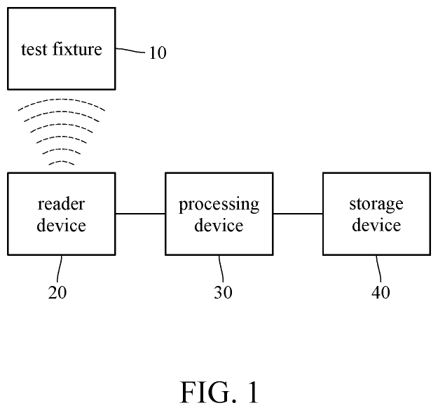

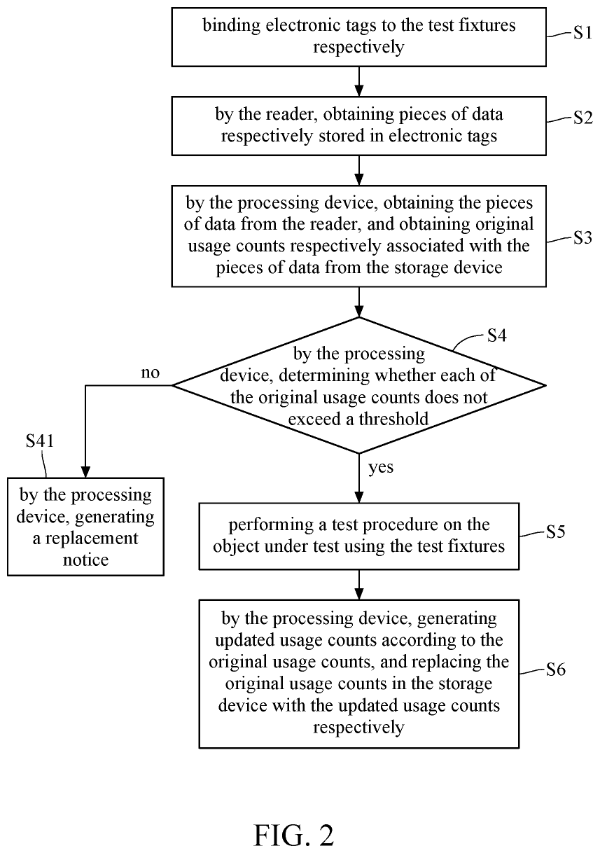

Please refer to FIGS. 1 and 2. The present disclosure provides a management method of test fixtures applied to a test procedure. In accordance with the spirit of the invention, an embodiment of the present disclosure is described below with FIG. 1, the block diagram of a device, and FIG. 2, the flow chart. FIG. 1 illustrates a test fixture 10, a reader device 20, a processing device 30 and a storage device 40, wherein the processing device 30 is connected to the reader device 20 and the storage device 40. The test fixture 10 may be any fixture used to assist or aid the test procedure. In this embodiment, the test fixture is implemented by memory. The reader device 20 may include a device configured to obtain or receive the data of an object, such as an electronic tag. For example, the reader device 20 is a device with one or more antennas, but not limited to this. In an implementation, the reader device 20 is a RFID reader. The processing device 30 may be configured to receive external data and perform subsequent actions. For example, the processing device 30 is a personal computer, a system on chip (SOC), a microcontroller unit (MCU), an embedded controller (EC), etc. The storage device 40 may be configured to read and write data. FIG. 1 simply shows essential elements to perform the method shown in FIG. 2, and the method in FIG. 2 is described in detail below. The management method of test fixtures of the present disclosure is applicable to the manufacturing and test procedure of a server or an in-vehicle electronic product.

Please refer to FIG. 2. An management method of text fixtures applied to a test procedure of an embodiment of the present disclosure includes the following steps: step S1, binding electronic tags to a number of test fixtures 10 respectively; step S2, by the reader device 20, obtaining pieces of data respectively stored in electronic tags; step S3, by the processing device 30, obtaining the pieces of data from the reader device 20, and obtaining original usage counts respectively associated with the pieces of data from the storage device 40; step S4, by the processing device 30, determining whether each of the original usage counts does not exceed a threshold; if any one of the original usage counts exceeds the threshold, performing step S41, generating a replacement notice by the processing device 30; if each of the usage counts does not exceed the threshold, performing step S5, performing a test procedure on the object under test using the test fixtures 10; and finally performing step S6, by the processing device 30, generating updated usage counts according to the original usage counts, and replacing the original usage counts in the storage device 40 with the updated usage counts respectively.

In an embodiment of the present disclosure, the test procedure to which the management method of text fixtures as mentioned above is applied is the test procedure of motherboards. In the example of FIG. 2, the test fixtures 10 may be memory, such as dual in-line memory modules (DIMM), etc. Herein, the electronic tags may each contain an electronic tag utilizing a radio frequency identification (RFID) system, which may be a wireless communication IC chip, but is not limited to this. More specifically, in step S1, each of the test fixtures 10 may be bound by an electronic tag, so that each of the test fixtures 10 and the electronic tag bound to it have correspondence therebetween. The electronic tags each stores data that can be used for identification.

In step S2, the reader device 20 may obtain signals of the electronic tags with the included antennas, and then the reader device 20 may generate pieces of data respectively associated to the signals according to the signals, wherein the pieces of data may each be serial number, serial code, identification code, etc.

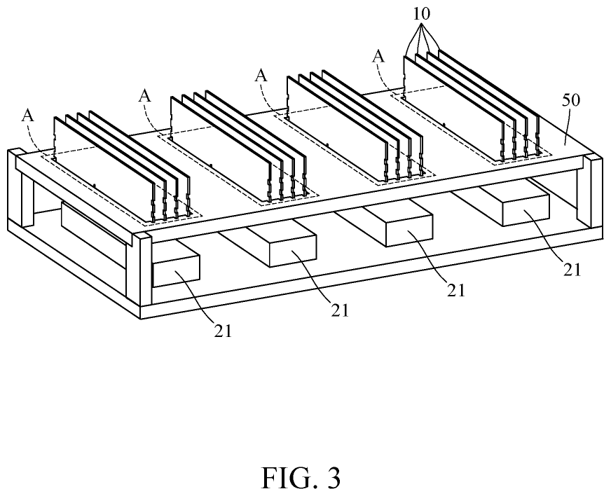

Please further refer to FIG. 3 for the description of the implementation of step S2. However, it should be noted that FIG. 3 merely shows one of ways to implement step S2, and is not intended to limit the implementation of step S2. FIG. 3 illustrates the test fixtures 10, a carrier 50 and the antennas 21 of the reader device 20. Although FIG. 3 does not show electronic tags, it can be seen from the above description that test fixtures are each bound by an electronic tag. The carrier 50 may be made of Bakelite, and has several regions A (although 4 regions A are shown in FIG. 3, the number of the regions of the invention is not limited to this. In practice, the number of the regions of the carrier 50 may be larger than, less than or equal to 4 according to different conditions or requirements). The test fixtures 10 are respectively disposed in the regions A (the number of the test fixtures 10 in each region A of the invention is not limited to that shown in FIG. 3. In practice, the number of the test fixtures 10 in each region A may be defined as different number according to different conditions or requirements). The antennas 21 are respectively disposed below the regions A. In the present disclosure, the combination of the antennas 21 and other components as shown in the figure is not limited. In an embodiment of the present disclosure, the antennas 21 may be combined with the carrier 50 (at the inner bottom of the carrier 50, on one side of the carrier 50, etc.) and respectively correspond to the regions A. In FIG. 3, the antennas are combined with the inner bottom of the carrier 50. By dividing serval regions A in the carrier 50, with the regions A respectively corresponding to the antennas 21 used to obtain data, it is possible to avoid the situation where the antennas and the test fixtures are too far and the signal therebetween is accordingly too weak. Moreover, depending on the actual data acquisition status, the relative distance, relative angle, etc. between each antenna 21 and the corresponding region A may be adjusted. In other embodiments, the antennas 21 may be disposed above, below or on one side of the moving path of the carrier 50, instead of being fixed to the carrier 50.

In step S3, after receiving the pieces of data, the processing device connected to the reader device 20 and the storage device 40 may accordingly request the storage device 40 for access to the usage counts respectively associated with the pieces of data. More specifically, each usage count is preferably an integer value that is a non-negative integer. Since the electronic tags are bound to the test fixtures 10, the integer value can be regarded as a record of the number of times the corresponding test fixture 10 is used.

Moreover, for ensuring that the data of all the test fixtures 10 can be obtained, in step S3, after obtaining the pieces of data from the reader device 20, the processing device 30 may first determine whether the total quantity of the pieces of data meets a testing quantity, and acquire the usage counts respectively associated with the pieces of data from the storage device 40 after determining that the total quantity of the pieces of data meets the testing quantity. For example, if 32 test fixtures 10 are required to perform the test, the testing quantity may be preset as 32. In this example, after determining that the quantity of the pieces of data respectively associated with the test fixtures 10 is 32, the processing device 30 then acquires the usage counts from the storage device 40.

In step S4, the processing device 30 determines whether each of the usage counts does not exceed a threshold. In practice, the test fixtures 10 have a certain damage rate, and are likely to be damaged due to overuse after being used several times. Through observation and experiments, it can be found that when the number of times of use exceeds a specific number, the damage rate of the test fixtures 10 is greatly increased. The threshold may be set as the specific number or slightly less than the specific number. The setting of the threshold is not limited except being greater than the initial setting value (e.g., 0) of the usage counts.

The replacement notice in step S41 may be implemented in multiple ways, such as the ringtone notification on the factory production line, the push notification that pops up on the electronic device of the relevant personnel, the warning information in the back-end server, etc. In practice, in an environment such as a factory, when an operator receives the replacement notice, the operator may accordingly know which piece of data correspond to the usage count that exceeds the threshold and its corresponding test fixture 10, and then replace the test fixture 10 associated with this piece of data with a new test fixture. After the replacement, the procedure of an embodiment of the present disclosure may be restarted from step S1.

The test procedure in step S5 may be one of various test procedures of the object under test using the test fixtures 10, which is not limited in the present disclosure. A detailed description of the test procedure is given as an example in the following but is not intended to limit the test procedure of the invention.

Step S6 is the step of updating the usage counts after the test procedure is completed. In practice, the processing device 30 may add 1 to each of the usage counts (original usage counts) to generate updated usage counts respectively, which represents that the test fixtures 10 are used in the test procedure once more. After that, the processing device 30 replaces the original usage counts in the storage device with the updated usage counts respectively.

In practice, after step S6, each test fixture 10 may be used continuously in other test procedures until the usage count associated with the test fixture 10 exceeds the threshold; thereby, the management of the test fixtures 10 may be achieved.

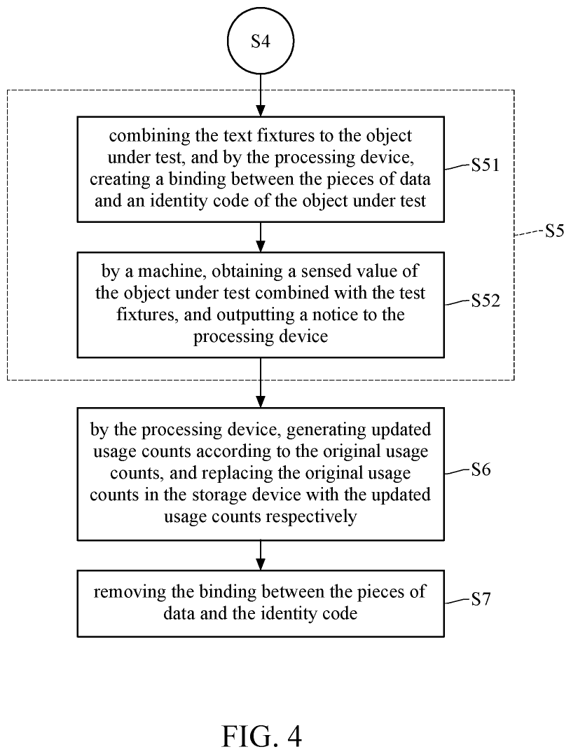

Please refer to FIG. 4. FIG. 4 is a detailed flow chart of another embodiment of the present disclosure, wherein step S5 includes step S51, combining the test fixtures 10 to the object under test, and by the processing device 30, creating a binding between the pieces of data and an identity code of the object under test; and step S52, by a machine, obtaining a sensed value of the object under test combined with the test fixtures 10, and outputting a notice to the processing device 30. In addition, after step S6 is performed, step S7, removing the binding between the pieces of data and the identity code, is performed.

For example, the object under test in step S51 is a motherboard, and the test fixtures 10 in step S51 are pieces of memory. The object under test has an identity code for recording or management. After the test fixtures 10 are combined with the object under test (i.e., the object under test are equipped with the test fixtures 10 for the test), the processing device 30 may bind the pieces of data to the identity code of the object under test to represent that the test fixtures 10 are used for the test of the object under test at this time, which may strengthen the management of the test fixtures 10.

The machine in step S52 may be a device for testing the object under test. The sensed value may be any value detected by the test procedure for the object under test, such as a voltage value, a current value, one of various signals, data, etc., but is not limited to this. After the test is completed (e.g., the machine obtains the sensed value), the machine may output a notice to the processing device 30. After receiving the notice, the processing device 30 performs step S6.

In step S7, after updating the usage counts in the storage device 40, the processing device 30 removes the binding between the pieces of data and the identity code, which represents the end of the test procedure of the object under test using the test fixtures 10.

In an embodiment of the present disclosure, the server to which the management method of test fixtures mentioned above is applicable may be used for artificial intelligence (AI) computing, edge computing, or be used as a 5G server, a cloud server or a server in Internet of Vehicles (IoV).

In an embodiment of the present disclosure, the in-vehicle electronic product to which the management method of test fixtures mentioned above is applicable may be applied to in-vehicle devices, such as autonomous vehicles, electric vehicles, semi-autonomous vehicles, etc.

In view of the above description, with the management method of text fixtures applied to a test procedure in the present disclosure, the pieces of data stored in the electronic tags respectively correspond to the test fixtures, the test fixtures are used to perform the test procedure on the object under test after the original usage counts are determined that none of them exceeds the threshold, and after the test procedure is completed, updated usage counts are generated according to the original usage counts, and the original usage counts in the storage device are respectively replaced by the updated usage counts. In this way, individual management of the test fixtures may be achieved, and at the same time, it may be ensured that the usage count of each of the test fixtures does not exceed the threshold.

What is claimed is:

1. A management method of test fixtures, applied to a test procedure, comprising:
binding a plurality of electronic tags to the test fixtures respectively;
by a reader device, obtaining a plurality of pieces of data respectively stored in the plurality of electronic tags;
by a processing device, obtaining the plurality of pieces of data from the reader device, and obtaining a plurality of original usage counts respectively associated with the plurality of pieces of data from a storage device;
by the processing device, determining whether each of the plurality of original usage counts does not exceed a threshold;
when each of the plurality of original usage counts does not exceed the threshold, performing the test procedure on an object under test using the test fixtures; and
after performing the test procedure, by the processing device, generating a plurality of updated usage counts according to the plurality of original usage counts, and replacing the plurality of original usage counts in the storage device with the plurality of updated usage counts respectively.

2. The management method of the test fixtures according to claim 1, wherein obtaining the plurality of pieces of data respectively stored in the plurality of electronic tags comprises:
placing the test fixtures on a carrier, wherein the carrier has a plurality of regions, and the test fixtures are disposed in the plurality of regions; and
obtaining a plurality of signals using a plurality of antennas respectively corresponding to the plurality of regions, and generating the plurality of pieces of data respectively associated with the plurality of signals.

3. The management method of the test fixtures according to claim 1, wherein obtaining the plurality of pieces of data from the reader device, and obtaining the plurality of original usage counts respectively associated with the plurality of pieces of data from the storage device comprising:
obtaining the plurality of pieces of data from the reader device;
determining whether a total quantity of the plurality of pieces of data meets a testing quantity; and
when the total quantity of the plurality of pieces of data meets the testing quantity, obtaining the plurality of original usage counts respectively associated with the plurality of pieces of data from the storage device.

4. The management method of the test fixtures according to claim 1, further comprising:
by a processing device, generating a replacement notice when any one of the plurality of original usage counts exceeds the threshold.

5. The management method of the test fixtures according to claim 1, wherein the test procedure comprises:
combining the test fixtures to the object under test, and by the processing device, creating a binding between the plurality of pieces of data and an identity code of the object under test; and
by a machine, obtaining a sensed value of the object under test combined with the test fixtures, and outputting a notice to the processing device, and
wherein generating the plurality of updated usage counts according to the plurality of original usage counts comprises:
after receiving the notice, adding 1 to each of the plurality of original usage counts to generate the plurality of updated usage counts.

6. The management method of the test fixtures according to claim 5, further comprising:
after replacing the plurality of original usage counts in the storage device with the plurality of updated usage counts respectively, removing the binding between the plurality of pieces of data and the identity code.
